(19) United States
(12) Patent Application Publication
(10) Pub. No.: US 2011/0150562 A1
(43) Pub. Date: Jun. 23, 2011

(54) Ball Stud Fastener

(75) Inventors: Karl-Eduard LUTZ, Feldatal (DE); Reiner RUEHL, Ulrichstein (DE)

(73) Assignee: KAMAX-WERKE RUDOLF KELLERMANN GMBH & CO. KG, Osterode am Harz (DE)

(21) Appl. No.: 12/960,633

(22) Filed: Dec. 6, 2010

(30) Foreign Application Priority Data
Dec. 18, 2009 (DE) 20 2009 014 886.6

(51) Int. Cl. F16C 11/06; F16B 35/00

(52) U.S. Cl. 403/122; 411/378

(57) ABSTRACT

A ball stud fastener (1) includes a stud stub (2) including a first free end (3), a threaded portion (4), an attachment channel (9), a bead (10), a cylindrical portion (11), a conical portion (12) and a second end (13). The threaded portion (4) is located in the region of the first free end (3). The attachment channel (9) is designed for attachment of a bellow (22) and the like to the stud stub (2), the attachment channel (9) being located between the threaded portion (4) and the conical portion (12) in an axial direction, the attachment channel (9) having a first axial end facing the conical portion (12), the first axial end being located next to the bead (10). The conical portion (12) is arranged between the bead (10) and the second end (13) in an axial direction. The bead (10) is produced by cold forming in an axial direction. The cylindrical portion (11) is located between the bead (10) and the conical portion (12), the cylindrical portion (11) resulting from cold forming of the bead (10). The ball stud fastener (1) further includes a ball (15) being fixedly connected to the second end (13) of the stud stub (2). The ball (15) is not designed as one piece with the stud stub (2) before being connected thereto.

### CROSS REFERENCE TO RELATED APPLICATIONS

This application claims priority to co-pending German Utility Model No. DE 20 2009 014 886.6 entitled “Kugelzapfen”, filed Dec. 18, 2009.

### FIELD OF THE INVENTION

The present invention generally relates to a ball stud fastener including a stud stub and a ball being connected thereto. The present invention also relates to a stud stub to be connected to a ball to form a ball stud fastener.

Such a ball stud fastener in combination with a bearing shell serves to form a ball-and-socket joint.

### BACKGROUND OF THE INVENTION

A ball stud fastener is known from German Patent Application No. DE 44 33 762 A1 corresponding to U.S. Pat. No. 5,611,635. The known ball stud fastener in combination with a bearing shell serves to form a ball-and-socket joint. The ball stud fastener includes a stud stub having a first free end, a threaded portion, an attachment channel for attachment of a bellow and the like to the stud stub, a conical portion and a second end. The threaded portion is located in the region of the first free end. The attachment channel is arranged between the threaded portion and the conical portion as seen in an axial direction, and at its axial end facing the conical portion, it is limited by a bead. The conical portion is arranged between the bead and the second end as seen in an axial direction. A ball is located at the second end of the stud stub, the ball being designed as one piece with the stud stub.

Another similar ball stud fastener having a one piece design is known from German Patent No. DE 10 2007 023 245 B4.

Another ball stud fastener is known from European Patent Application No. EP 0 667 464 A2 corresponding to U.S. Pat. No. 6,113,303. The known ball stud fastener in combination with a bearing shell serves to form a ball-and-socket joint. The ball stud fastener includes a stud stub having a first free end, a threaded portion, an attachment channel for attachment of a bellow and the like to the stud stub and a second end. The threaded portion in located in the region of the free end. The attachment channel is arranged between the threaded portion and a cylindrical portion as seen in an axial direction, and at its axial end facing the cylindrical portion, it is limited by a bead. The cylindrical portion is arranged between the bead and the second end as seen in an axial direction, and it extends in a way to reach the second end. A ball is fixedly connected to the second end of the stud stub, the ball not being designed as one piece with the stud stub, but instead being subsequently connected to the stud stub. This means that the ball stud fastener includes two separate pieces, namely the stud stub and the ball, which are subsequently interconnected in the sense of a modular system by combining identically designed balls and differently designed stud stubs. According to the description of this document, the stud stub has been produced by cold forming, especially by cold trap die extrusion. A stud stub not including a ball is also known from this document.

Other ball stud fasteners are known from PCT Applications WO 2005/021184 A1, WO 2005/051594 A2 corresponding to U.S. Patent Application No. US 2009/0038157 A1, and WO 2005/106263 A1 corresponding to U.S. Patent Application No. US 2007/0211972 A1, European Patent Application No. EP 0 898 090 A2 corresponding to U.S. Pat. No. 5,951,195, European Patent No. EP 1 446 587 B1 corresponding to U.S. Pat. No. 7,097,381 B2, German Patent Applications DE 195 42 071 A1 corresponding to U.S. Pat. No. 5,752,780 and DE 10 2006 017 373 A1 and German Utility Model Nos. DE 20 2008 006 650 U1, DE 202 18 262 U1 corresponding to U.S. Patent Application No. US 2004/0105721 A1, and DE 20 2006 001 771 U1.

Another ball stud fastener is known from German Patent Application No. DE 10 2005 014 905 A1 and German Utility Model No. DE 20 2004 005 272 U1. The known ball stud fastener in combination with a bearing shell serves to form a ball-and-socket joint. The ball stud fastener includes a stud stub having an attachment channel for attachment of a bellow and the like. The ball stud fastener at one end includes a ball being designed as one piece with the stud stub. Next to the ball, the ball stud fastener includes an elongated cylindrical portion followed by the attachment channel. Next, there is a bead including chamfers extending in both axial directions and being followed by another cylindrical portion. The bead has been produced by upsetting the ball stud fastener in an upsetting tool and by cold trap die extrusion, respectively. In this way, the bead limiting the attachment channel in a direction facing away from the ball is produced by cold forming.

### SUMMARY OF THE INVENTION

The present invention relates to a ball stud fastener including a stud stub. More particularly, the present invention relates to a ball stud fastener including a stud stub including a first free end, a threaded portion, an attachment channel, a bead, a cylindrical portion, a conical portion and a second end. The threaded portion is located in the region of the first free end. The attachment channel is designed for attachment of a bellow and the like to the stud stub, the attachment channel being located between the threaded portion and the conical portion in an axial direction, the attachment channel having a first axial end facing the conical portion, the first axial end being located next to the bead. The conical portion is arranged between the bead and the second end in an axial direction. The bead is produced by cold forming in an axial direction. The cylindrical portion is located between the bead and the conical portion, the cylindrical portion resulting from cold forming of the bead. The ball stud fastener further includes a ball being fixedly connected to the second end of the stud stub. The ball is not designed as one piece with the stud stub before being connected thereto.

The present invention also relates to a stud stub to be connected to a ball for forming a ball stud fastener in this way.

The term of axial forming or forming in an axial direction as used in this application is to be understood as meaning that the movement of the forming tool causing deformation of the ball stud fastener substantially takes place in an axial direction. In this way, forming in an axial direction as used herein is not only to be differentiated from methods producing chips such as turning or milling operations, but also from forming methods being substantially defined by a forming movement in an axial direction. Such known radial forming methods use tools being divided in a circumferential direction, the tools being moved towards one another in a radial direction. Forming in an axial direction, however, does not mean that the material of the stud stub is only deformed in an axial direction. Instead, the movement of the forming tool in an axial direction causes deformation of the material of the stud stub both in an axial and a radial direction. In this way, the novel ball stud fastener can be produced with comparatively simple tools in a cost effective way.

The starting point of the invention is a ball stud fastener including a conical portion serving to realize the desired angular movement of the stud stub in the corresponding ball socket of the ball-and-socket joint. The angular movement is defined by the dimension and the cone angle of the conical portion. It is to be understood that such a conical portion extends over a substantial portion of the length of the stud stub and that a rather short chamfer or a bezel are not to be interpreted as such a conical portion. The axial length of l₁ of the conical portion may be greater than 3 mm, preferably between approximately 3 to 7 mm or more. The cylindrical portion has a diameter d. The ratio of l₁/d is at least 30%, preferably between approximately 40 to 50%, and it may also be up to approximately 70 or even 80%. A rounded portion may be arranged between the conical portion and the cylindrical portion. The sum of the axial lengths l₂ of the conical portion and the rounded portion may be greater than 3 mm, preferably between approximately 3 to 7 mm or more. The cylindrical portion has a diameter d. The ratio of l₂/d is at least 30%, preferably between approximately 40 to 50%, and it may also be up to approximately 70 or even 80%.

In contrast to the above described known prior art ball stud fasteners including such a conical portion, the novel stud stub and the ball are designed as separate elements, i.e. they are not designed as one piece and the stud stub and the ball are separately produced and subsequently fixedly interconnected. For example, this connection may be realized by welding, staking, screwing, riveting or other suitable connection methods.

Consequently, the present invention also relates to a stud stub as an intermediate product serving to be used for producing a ball stud fastener by later connecting it to a ball. In this way, one attains the possibility of combining identically designed or differently designed stud stubs with identically designed or differently designed balls for attaining a multitude of permutations of ball stud fasteners.

Preferably, the stud stub and the ball are made of metal. Especially, in combination with a corresponding ball socket also being made of metal or being made of plastic material, they serve to form a ball-and-socket joint. Such ball-and-socket joints are especially used in automobiles, for example for stabilizer studs or in the steering gear of automobiles. However, there is a multitude of other possible fields of application.

In the prior art, it is known to either use methods producing chips - especially turning, milling or cutting in—or comparatively complex radial forming methods for producing the attachment channel of the stud stub. The above described prior art according to German Patent Application No. DE 44 33 762 A1 does not include any statement or indication how the attachment channel is produced. The same applies to German Patent No. DE 10 2007 023 245 B4. The other prior art reference according to European Patent Application No. EP 0 667 464 A2 does not include the conical portion. The same applies to German Patent Application No. DE 10 2005 014 905 A1 and German Utility Model No. DE 20 2004 005 272 U1. The known cylindrical portion being connected to the bead also has the disadvantage compared to the conical portion according to the invention that it has lower bending strength.

The conical portion of the novel ball stud fastener serves to ensure the desired angular movement of the ball stud fastener in the ball socket of the ball-and-socket joint, the dimensions and the cone angle of the conical section determining the angular movement. The ball stud fastener according to European Patent Application No. EP 0 667 464 A2, German Patent Application No. DE 10 2005 014 905 A1 and German Utility Model No. DE 20 2004 005 272 U1 does not include this important functionality. European Patent Application No. EP 0 667 464 A2 only generally states that the stud stub is produced by cold forming, but does not include any statements how this is actually realized. Due to the design of the channel and of the bead of the known stud stub, a person with skill in the art realizes that the channel and the bead presumably have been produced by a comparatively complex and expensive method. Such a geometry cannot be produced by trap die extrusion. It is imaginable that a separated tool is used which, however, causes the problem that an unpreventable burr is produced in the region of the division of the tool, the burr having a negative influence on the desired sealing effect of the channel. However, it is likely that the channel is produced by turning or cutting in. German Patent Application No. DE 10 2005 014 905 A1 and German Utility Model No. DE 20 2004 005 272 U1 teach a comparatively complicated divided tool including three parts resulting in the above described drawbacks.

The present invention has now chosen a completely different concept for attaining the goal of a cost effective and flexible production of a stud stub of a ball stud fastener. The ball stud fastener is originally designed to include two parts in the sense of the ball and the stud stub being separately produced and being connected during a later process step. The stud stub is produced by a multistage method, for example in a multistage press. An important method step is that the bead is produced by an axial forming movement resulting in the attachment channel being produced, the attachment channel serving for assembly of a bellow and the like. For this purpose, a sufficient amount of material is supplied in the region of the end of the stud stub later facing the ball, the material of the stud stub being elastically and plastically deformed by a simple axial forming movement to produce the bead. For example, this may be realized by a simple annular forming tool in a multistage press. The forming tool moves in an axial direction into the material of the stud stub, and it contacts the material with its front as well as with its inner circumferential surface. In this way, one attains some sort of a step being located at the stud stub, the radial part of the step being the limit or border of the bead and the axial part of the step being a newly produced cylindrical portion. The forming tool could also have a different design and shape in this region—especially a design similar to a chamfer - such that the axial part of the step is not exactly located in an axial direction.

During a previous step, the base of the channel and the adjacent end portion are produced by a suitable forming process, for example upsetting, reducing or trap die extrusion. The second end of the stud stub is the one which is later connected to the ball, for example by welding, friction welding, staking or calking.

The novel method of forming does not require special tools as they are used in the prior art. Due to the preferred simple annular forming tool, the part of the stud stub the diameter of which is greater than the inner diameter of the annular forming tool is deformed. This part is then pushed in an axial direction towards the first free end including the threaded portion. Due to the resistance provided by the first free end of the stud stub, the material is simultaneously deformed by the annular deforming tool in an outer direction to thus form the annular bead. In this way, one also produces the shape of the cylindrical portion.

The threaded portion may be located directly at the first free end. However, other arrangements are also possible and are intended to be included in the rather broad term of the region of the first free end as used herein. Thus, for example, it is possible to arrange a centering portion at the first free end and to arrange the threaded portion adjacent to the centering portion.

The design and the shape of the flank of the bead facing the thread depend on the strength and the deformation properties of the used material of the stud stub. For reasons of simplicity, the bead is preferably not supported by a tool to maintain the tool as simple as possible. Practical tests as well as a multitude of FEA simulations (FEA=finite elements analysis) have shown that the flanks of the beads being produced with this method especially in the region of it smaller diameter can be produced to be approximately straight. It is preferred to produce angles with respect to the longitudinal axis of the stud stub of approximately between 45° to 60°. Smaller angles are also possible, but they reduce the retaining function of the bead with respect to the bellow to be connected thereto. Other angles can be easily produced in the outer portion of the bead by designing the forming tool differently. It is possible to design the angle of the flank facing the thread to be significantly more steep than the angle produced at the smaller diameter of the bead. However, in this way, the danger of an burr being formed in the transition region between the flank facing the thread and the greater diameter is increased. Practically, it has been found that it is sufficient to work with a straight forming tool and to produce a substantially straight flank.

The substantially straight shape of the flank makes it easier to adapt the shape of the bellow to the attachment channel and to the bead, respectively.

It is also possible to narrow the outer diameter of the bead by a respective design of the forming tool, for example not to exceed a maximum measure, to be within certain tolerances or to prevent a sharp edge at the outer contour by suitably designing the forming tool, for example. Similar applies to the production of the limiting surface of the bead facing the ball. For example, it is very easy to impress annular channels at this place.

There is a multitude of different possibilities for designing the end of the stud stub facing the thread. For example, a thread with or without an internal engagement surface for a tool, different cone shapes—for example for supporting a conical counter part -, a thread including a dog point with or without an external engagement surface, and the like can be realized. A collar may be arranged in the axial center region. The collar may or may not include a tool engagement surface, a hexagon drive engagement surface, a external multipoint drive engagement surface or other tool engagement surfaces.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a view of a first exemplary embodiment of the novel ball stud fastener.

FIG. 2a is a view of the first exemplary embodiment of the novel ball stud fastener according to FIG. 1 in a first manufacturing state.

FIG. 2b is a view of the first exemplary embodiment of the novel ball stud fastener according to FIG. 1 during a manufacturing step taking place after the first manufacturing state illustrated in FIG. 2a.

FIG. 3 is a view of a second exemplary embodiment of the novel ball stud fastener with a bellow being mounted thereto.

FIG. 4 is a view of a third exemplary embodiment of the novel ball stud fastener.

FIG. 5 is a view of a fourth exemplary embodiment of the novel ball stud fastener.

### DETAILED DESCRIPTION

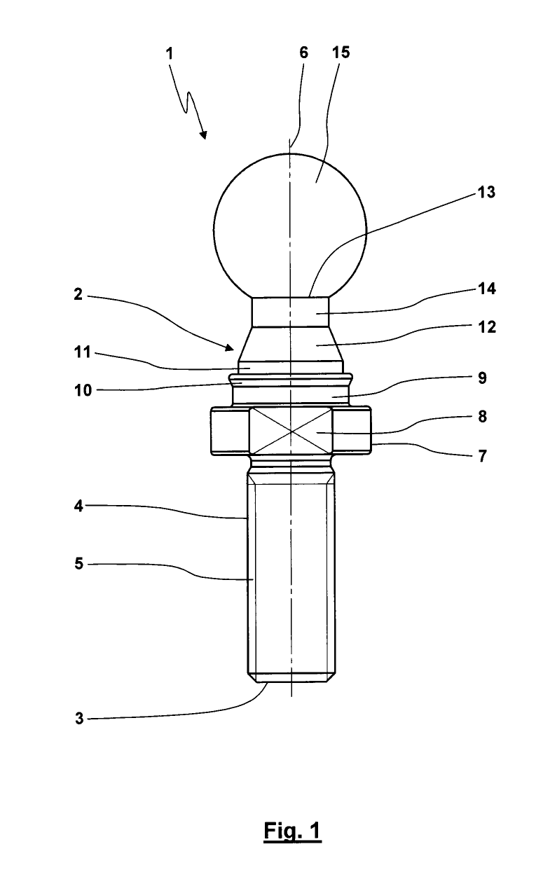

Referring now in greater detail to the drawings, FIG. 1 illustrates a first exemplary embodiment of a novel ball stud fastener 1. Such a ball stud fastener 1 in combination with a corresponding ball socket (not illustrated) serves to form a ball-and-socket joint (not illustrated). The ball stud fastener 1 is especially made of metal and used in the steering gear of an automobile.

The ball stud fastener 1 includes a stud stub 2 having a first free end 3 and a threaded portion 4 including a thread 5, the threaded portion 4 being located next to the free end 3 as seen in an axial direction. The thread 5 may be a metric thread or any suitable other thread. In the illustrated exemplary embodiment, the threaded portion 4 is located directly at the free end 3. However, other arrangements are also possible.

An actuation portion 7 is located in the same direction along the longitudinal center axis 6 of the ball stud fastener 1. In the illustrated exemplary embodiment, the actuation portion 7 is designed as a two flats drive 32, and it includes two engagement surfaces 8 for engagement of a tool wrench for rotatingly actuating the ball stud fastener 1. The engagement surfaces 8 are displaced by 180° to oppose one another. It is to be understood that FIG. 1 thus only illustrates one of the two engagement surfaces 8. Other designs are also possible.

Further on in this direction, there is an attachment channel 9 for attachment of a bellow, a dust cap and the like to the stud stub 2. The attachment channel 9 as further seen in the same direction (i.e. facing away from the actuation portion 7) is limited by a bead 10. A cylindrical portion 11 is located next to the bead 10. The bead 10 is designed to be asymmetric in an axial direction, and with its portion facing the cylindrical portion 11 it is connected to the cylindrical portion 11 by an angle of approximately 90°. The angle in the direction towards the attachment channel 9 is significantly greater in the sense that the transition is less abrupt and step-like. A conical portion 12 is located next to the cylindrical portion 11. The conical portion 12 extends along a substantial portion of the length of the stud stub 2, and it is especially not to be understood as being designed as a rather short chamfer or a bezel.

A ball 15 is fixedly connected to the stud stub 2 in the region of the second end 13 of the stud stub 2. The stud stub 2 and the ball 15 are not designed as one piece, but they are instead separately and independently produced and are then interconnected by a suitable method, as for example welding, friction welding, staking, calking, screwing or riveting.

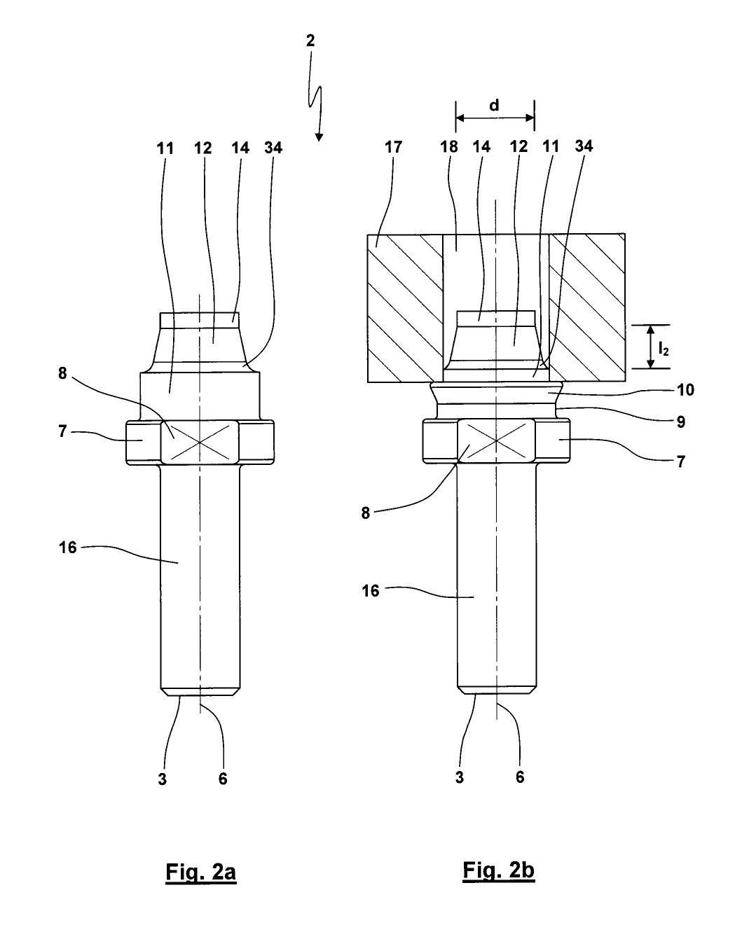

The bead 10 was produced by pure axial cold forming, especially pure axial metal cold forming. This means that the movement of the forming tool is a substantially pure axial movement. This does not mean that the material of the stud stub 2 during forming has only been deformed in an axial direction. Due to the forming movement, one attains the bead 10 and the cylindrical portion 11 being located between the bead 10 and the conical portion 12, as this will be further explained in greater detail with reference to the illustrations of FIG. 2a and FIG. 2b.

FIG. 2a and FIG. 2b illustrate a part of the forming method for producing the stud stub 2 of the ball stud fastener 1 according to FIG. 1. A rounded portion 34 is arranged between the conical portion 12 and the cylindrical portion 11. The sum of the axial lengths l₂ of the conical portion 12 and the rounded portion 34 is greater than 3 mm, preferably between approximately 3 to 7 mm or more. The cylindrical portion 11 has a diameter d. The ratio of l₂/d is at least 30%, preferably between approximately 40 to 50%, and it may also be up to approximately 70 or even 80%.

FIG. 2a illustrates the condition of the stud stub 2 before the channel 9 and the bead 10 are produced. It is to be seen that the stud stub 2 does not yet include a threaded portion 4, but instead the shank portion 16 being located at this place. Furthermore, it is to be seen that the cylindrical portion 11 has a greater diameter compared to its diameter after conducting the forming process. The ball 15 is not yet connected to the stud stub 2.

FIG. 2b illustrates the actual forming process for producing the attachment channel 9 and the bead 10. The forming movement exclusively takes place in an axial direction. Preferably, it is realized by cold forming, especially by a simple upsetting process. This process is especially realized by an annular forming tool 17. The forming tool 17 includes a cylindrical bore 18 being arranged in the center, the bore 18 serving for arrangement of the diminished end portion of the stud stub 2. Starting from the illustration of FIG. 2a, the forming tool 17 is moved downward in an axial direction towards the first free end 3 of the stud stub 2. For example, this is realized in a multistage heading machine. During this movement, the forming tool 17 engages the portions of the material of the stud stub 2 the outer diameter of which is greater than the inner diameter of the bore 18 of the forming tool 17. Due to the resistance supplied by the free end 3 of the stud stub 2, the material is deformed in the region of the cylindrical portion 11 (see FIG. 2a) such that the bead 10 and the channel 9 limited thereby are produced. This deformation results in the cylindrical portion 14 being located next to the attachment channel 9 and the bead 10 being produced. This cylindrical portion 14 is characteristic for the bead 10 which has been produced by a pure axial forming movement.

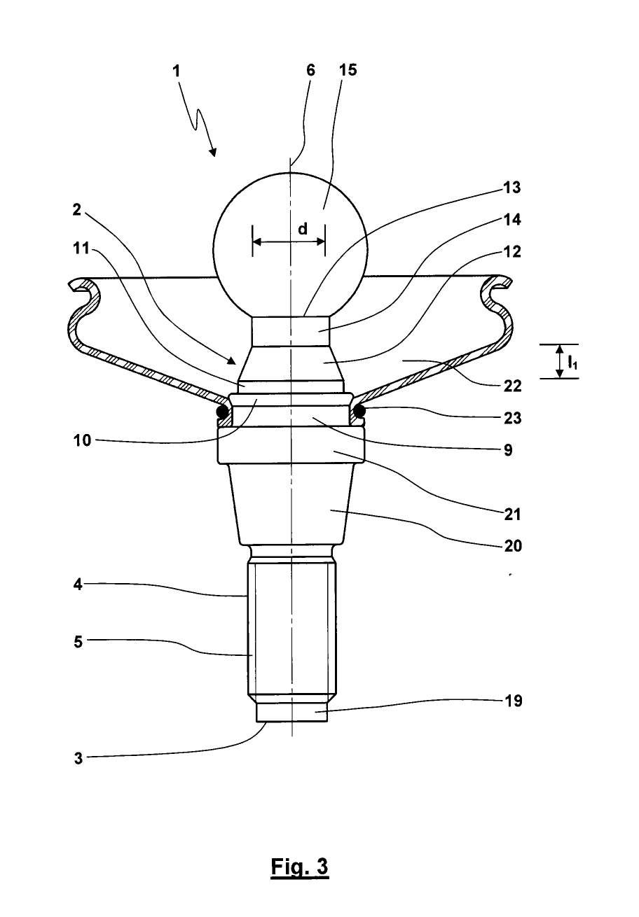

FIG. 3 illustrates a second exemplary embodiment of the ball stud fastener 1 in an exemplary mounting situation. With respect to the features corresponding to the other exemplary embodiments, it is referred to the respective part of the description. In contrast to the ball stud fastener 1 illustrated in FIG. 1, the ball stud fastener 1 in this case includes a centering portion 19 being located in the region of the first free end 3. Furthermore, instead of the actuation portion 7, the ball stud fastener 1 includes a conical portion 20 and another cylindrical portion 21. The attachment channel 9 is located next to the cylindrical portion 21.

FIG. 3 illustrates a possible mounting situation of the ball stud fastener 1 in the sense of connecting it to a bellow 22. The bellow 22 is especially designed as a sealing bellow or a dust cap by which the ball-and-socket joint (not illustrated) formed by the stud stub 2 engaging a ball socket (not illustrated) is sealed. The bellow 22 is especially made of elastically deformable plastic material, and it supplies the desired sealing effect with respect to the attachment channel 9. In the illustrated exemplary embodiment, this is realized by a spring 23. However, other ways of connecting the bellow 22 to the ball stud fastener 1 are also possible.

The axial length l₁ of the conical portion 12 is greater than 3 mm, preferably between approximately 3 to 7 mm or more. The cylindrical portion 11 has a diameter d. The ratio of l₁/d is at least 30%, preferably between approximately 40 to 50%, and it may also be up to approximately 70 or even 80%.

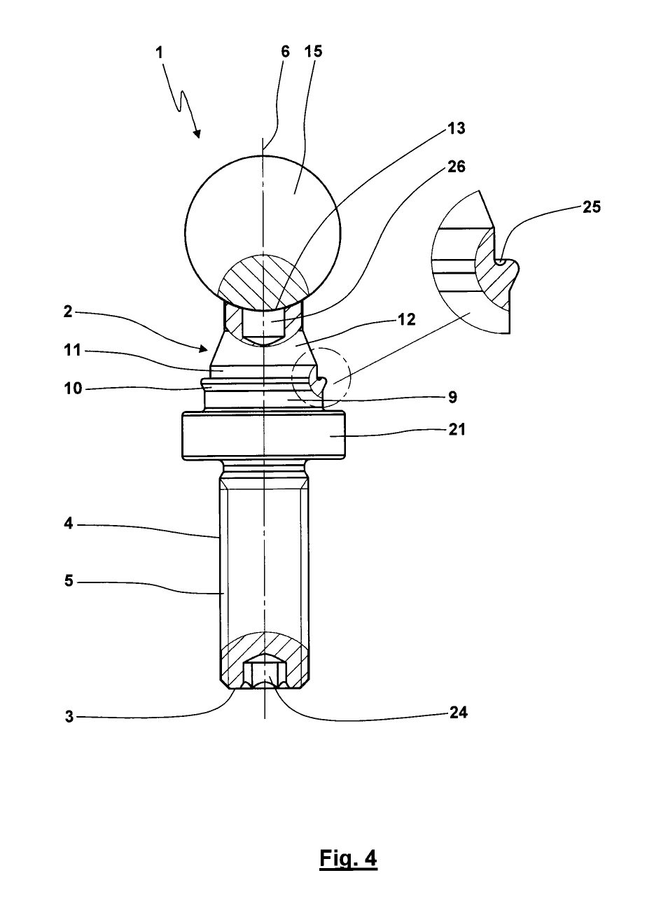

FIG. 4 illustrates a third exemplary embodiment of the novel ball stud fastener 1. With respect to the features corresponding to the other exemplary embodiments, it is referred to the respective part of the description. In contrast to the above described exemplary embodiments, the ball stud fastener 1 according to FIG. 4 includes an actuation portion 7 being designed as a internal hexagon drive 24 being arranged in the region of the first free end 3 of the stud stub 2. As it is to be seen from the enlarged portion in FIG. 4, an undercut 25 is located in the region of the bead 10. Furthermore, the upper portion of the stud stub 2 includes a recess 26 serving to reduce the mass and the weight, respectively, of the ball stud fastener 1.

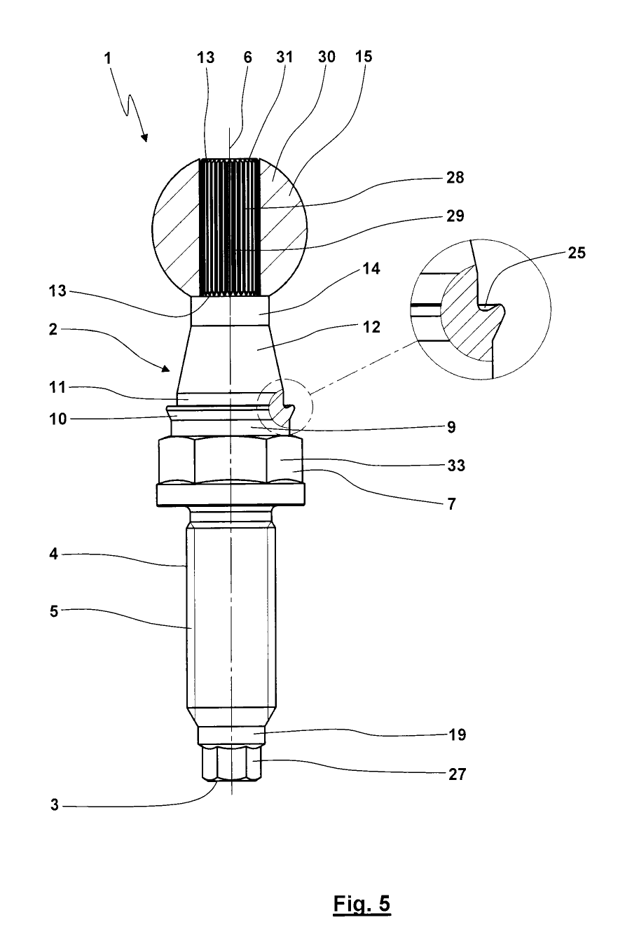

FIG. 5 illustrates another exemplary embodiment of the ball stud fastener 1. With respect to the features corresponding to the other exemplary embodiments, it is referred to the respective part of the description. In this case, the actuation portion 7 is designed as a first external hexagon drive 27 being located approximately in the axial center region of the ball stud fastener 1 and a second external hexagon drive 33 being located in the region of the first free end 3. A ball attachment portion 28 is arranged in the region of the opposite axial end 13. In the illustrated exemplary embodiment, the portion 28 includes a knurling 29. The ball 15 is designed as a hollow ball 30 including an opening 31. The knurling 29 engages the opening 31 and the material of the hollow ball 30 surrounding the opening 31, respectively, in the sense of a press fit such that a fixed connection of the hollow ball 30 with the stud stub 2 is realized. In this case, the second end 13 of the stud stub 2 is to be understood in a way that it is formed by the entire portion in which the knurling 29 is arranged, the knurling 29 being fixedly connected to the ball 15 being designed as a hollow ball 30.

Many variations and modifications may be made to the preferred embodiments of the invention without departing substantially from the spirit and principles of the invention. All such modifications and variations are intended to be included herein within the scope of the present invention, as defined by the following claims.

We claim:

1. A ball stud fastener, comprising:
a stud stub including a first free end, a threaded portion, an attachment channel, a bead, a cylindrical portion, a conical portion and a second end,
the threaded portion being located in the region of the first free end,
the attachment channel being designed for attachment of a bellow and the like to the stud stub, the attachment channel being located between the threaded portion and the conical portion in an axial direction, the attachment channel having a first axial end facing the conical portion, the first axial end being located next to the bead,
the conical portion being arranged between the bead and the second end in an axial direction,
the bead being produced by cold forming in an axial direction, and
the cylindrical portion being located between the bead and the conical portion,
the cylindrical portion resulting from cold forming of the bead; and
a ball, the ball being fixedly connected to the second end of the stud stub, the ball not being designed as one piece with the stud stub before being connected thereto.

2. The ball stud fastener of claim 1, wherein the conical portion has an axial length and the cylindrical portion has a diameter, the ratio between the axial length and the diameter being at least approximately 30%.

3. The ball stud fastener of claim 1, wherein a rounded portion is arranged between the conical portion and the cylindrical portion, the conical portion having a first axial length, the rounded portion having a second axial length and the cylindrical portion having a diameter, the ratio between the sum of the first and second axial lengths and the diameter being at least approximately 30%.

4. The ball stud fastener of claim 1, wherein the bead is designed to be asymmetric in an axial direction.

5. The ball stud fastener of claim 4, wherein the bead has a first axial portion facing the conical portion, the first axial portion being connected to the cylindrical portion at an angle of approximately 90°.

6. The ball stud fastener of claim 1, wherein the ball stud fastener has a longitudinal center axis and the bead has a flank having a first smaller diameter and a second greater diameter, the flank in the region of the first smaller diameter being designed to be straight and to be arranged with respect to the longitudinal center axis at an angle of approximately between 30° and 60°.

7. The ball stud fastener of claim 6, wherein the angle is approximately between 45° and 60°.

8. The ball stud fastener of claim 1, wherein the bead has been produced by upsetting.

9. A stud stub, comprising:
a first free end;
a threaded portion;
an attachment channel;
a bead;
a cylindrical portion;
a conical portion; and
a second end,
the threaded portion being located in the region of the first free end,
the attachment channel being designed for attachment of a bellow and the like to the stud stub, the attachment channel being located between the threaded portion and the conical portion in an axial direction, the attachment channel having a first axial end facing the conical portion, the first axial end being located next to the bead,
the conical portion being arranged between the bead and the second end in an axial direction,
the bead being produced by cold forming in an axial direction, and
the cylindrical portion being located between the bead and the conical portion,
the cylindrical portion resulting from cold forming of the bead.

10. The stud stub of claim 9, wherein the conical portion has an axial length and the cylindrical portion has a diameter, the ratio between the axial length and the diameter being at least approximately 30%.

11. The stud stub of claim 9, wherein a rounded portion is arranged between the conical portion and the cylindrical portion, the conical portion having a first axial length, the rounded portion having a second axial length and the cylindrical portion having a diameter, the ratio between the sum of the first and second axial lengths and the diameter being at least approximately 30%.

12. The stud stub of claim 9, wherein the bead is designed to be asymmetric in an axial direction.

13. The stud stub of claim 12, wherein the bead has a first axial portion facing the conical portion, the first axial portion being connected to the cylindrical portion at an angle of approximately 90°.

14. The stud stub of claim 9, wherein the ball stud fastener has a longitudinal center axis and the bead has a flank having a first smaller diameter and a second greater diameter, the flank in the region of the first smaller diameter being designed to be straight and to be arranged with respect to the longitudinal center axis at an angle of approximately between 30° and 60°.

15. The stud stub of claim 14, wherein the angle is approximately between 45° and 60°.

16. The stud stub of claim 9, wherein the bead has been produced by upsetting.

17. The stud stub of claim 9, wherein the second end is designed and configured to be connected to a ball for attaining a ball stud fastener.
